(19) United States
(12) Patent Application Publication
(10) Pub. No.: US 2015/0168785 A1
(43) Pub. Date: Jun. 18, 2015

(54) LIQUID CRYSTAL DISPLAY PANEL AND MANUFACTURING METHOD THEREOF

(71) Applicant: Shenzhen China Star Optoelectronics Technology Co., Ltd., Shenzhen (CN)

(72) Inventor: Liang Xu, Shenzhen (CN)

(21) Appl. No.: 13/701,523

(22) PCT Filed: Sep. 7, 2012
(86) PCT No.: PCT/CN2012/081136

§ 371 Date: Dec. 3, 2012

(30) Foreign Application Priority Data
Aug. 10, 2012 (CN) 201210284913.1

(51) Int. Cl. G02F 1/1343; G02F 1/1337; G02F 1/1333

(52) U.S. Cl. CPC G02F 1/134309; G02F 1/133345; G02F 1/133753; G02F 2001/133761

(57) ABSTRACT

The present invention provides a liquid crystal display panel and a manufacturing method thereof, the liquid crystal display panel comprises a first substrate which is provide with common electrodes and pixel electrodes thereon; a second substrate disposed opposite to the first substrate; a liquid crystal layer formed between the first substrate and the second substrate and including positive liquid crystal molecules which have a pre-tilt angle. The present invention can improve the efficiency of the alignment, save cost, and be suitable for large-scale production.

### FIELD OF THE INVENTION

The present invention relates to a field of liquid crystal display technology, and more particularly to a liquid crystal display panel and a manufacturing method thereof.

### BACKGROUND OF THE INVENTION

A liquid crystal display (LCD) is applied widely to the various electric products, and most of liquid crystal displays are backlight liquid crystal displays which are composited by a liquid crystal display panel and a backlight module. Because the liquid crystal display has advantages such as a lighter weight, a smaller volume and smaller power consumption, etc., it is used in more and more applications.

Traditionally, two kinds of widely applied liquid crystal displays are a Vertical alignment (VA) type liquid crystal display and an in-plan switching (IPS) type liquid crystal display.

The VA-type liquid crystal display can be classified into various types; one is a polymer-stabilized vertical alignment (PSVA) type liquid crystal display. Because the PSVA-type liquid crystal display has various advantages such as wider viewing angles, a higher aperture ratio, a higher contrast ratio, and a simpler manufacturing process, so that it gradually becomes the popular trend of the VA-type liquid crystal display.

In the PSVA-type liquid crystal display, negative liquid crystal molecules are filled into the liquid crystal layer between two transparent substrates with reactive monomers. The reactive monomers are mixed in the negative liquid crystal molecules, and the surface of each of the transparent substrates is coated with polyimide (PI) as alignment base material. Next, when applying the voltage and the ultraviolet light (UV) to the two transparent substrates, the phase separation occurs in the reactive monomers and the liquid crystal molecules to form polymers on the alignment base materials of the transparent substrates. Due to the interaction the polymers and the liquid crystal molecules, the liquid crystal molecules will be arranged along the direction of the polymeric molecules. Therefore, the liquid crystal molecules between the transparent substrates can have the pre-tilt angles. However, the liquid crystal molecules in the PSVA-type liquid crystal display are the negative liquid crystal molecules, and the rotational viscosity of the negative liquid crystal molecules is higher, so that the response speed of the liquid crystal molecules is slower and thus the display performance of liquid crystal panel is affected.

In the IPS-type liquid crystal display, the surface of each of the transparent substrates is formed with an alignment layer, and pixel electrodes and common electrodes are disposed on the same substrate. In the liquid crystal layer, the liquid crystal molecules are originally arranged horizontally, and then a voltage is applied to the pixel electrode and the common electrode, an electric field occurred between the pixel electrode and the common electrode. The liquid crystal molecules under the effect of the electric fields are twisted according to the alignment of the alignment layer, and thus to control the light to pass through or not. However, in the manufacturing process, in order to ensure the display effect of the IPS-type liquid crystal display, operating rubbing alignment to the alignment layer is needed, and the requirements of the rubbing alignment are higher so that the process is difficult to control and thus the large-scale production is impacted.

In conclusion, because the IPS-type liquid crystal display requires operating the rubbing alignment to the alignment layer, the process is difficult to control and the large-scale production is impacted; PSVA-type liquid crystal display requires using the negative liquid crystal molecules, however, the rotational viscosity of the negative liquid crystal molecules is higher to impact the response speed.

As a result, it is necessary to solve the technique problems existing in the conventional technologies, as described above.

### SUMMARY OF THE INVENTION

The present invention provides a liquid crystal display panel and the display device of its applications to solve the technology problems of the conventional technologies. Because the IPS-type liquid crystal display requires operating the rubbing alignment to the alignment layer, the process is difficult to control and the large-scale production is impacted; and PSVA-type liquid crystal display requires using the negative liquid crystal molecules, however, the rotational viscosity of the negative liquid crystal molecules is higher to impact the response speed and thus reduce the efficiency of the production.

A primary object of the present invention is to provide a liquid crystal display panel, which comprises:

a first substrate provided with common electrodes and pixel electrodes thereon, wherein the pixel electrodes and the common electrodes are alternately arranged, and a plurality of the alignment display regions are formed by the pixel electrodes and the common electrodes arranged alternately;

a second substrate disposed opposite to the first substrate; and

a liquid crystal layer formed between the first substrate and the second substrate, and including positive liquid crystal molecules which have a pre-tilt angle, wherein the pre-tilt angle of the positive liquid crystal molecules corresponding to each of the alignment display regions is different.

In one embodiment of the present invention, the pixel electrodes and the common electrodes are formed on the same layer.

In one embodiment of the present invention, an insulation layer is formed on the common electrodes, and the pixel electrodes are formed on the insulation layer.

In one embodiment of the present invention, the pixel electrodes and the common electrodes have bent structures and are alternately arranged.

In one embodiment of the present invention, the pixel electrode includes a first trunk portion and first branch portions, a first preset angle is defined between the first trunk portion and the first branch portion; the common electrode includes a second trunk portion and second branch portions, a second preset angle is defined between the second branch portion and the second trunk portion; wherein the first branch portions and the second branch portions are parallel to each other and alternatively arranged.

Another object of the present invention is to provide a liquid crystal display panel, which comprises:

a first substrate provided with common electrodes and pixel electrodes thereon;

a second substrate disposed opposite to the first substrate; and

a liquid crystal layer formed between the first substrate and the second substrate, and including positive liquid crystal molecules which have a pre-tilt angle.

In one embodiment of the present invention, the pixel electrodes and the common electrodes are formed on the same layer.

In one embodiment of the present invention, an insulation layer is formed on the common electrodes, and the pixel electrodes are formed on the insulation layer.

In one embodiment of the present invention, the pixel electrodes and the common electrodes are alternately arranged, and a plurality of the alignment display regions are formed by the pixel electrodes and the common electrodes arranged alternately.

In one embodiment of the present invention, the pixel electrodes and the common electrodes have bent structures and are alternately arranged.

In one embodiment of the present invention, the pixel electrode includes a first trunk portion and first branch portions, a first preset angle is defined between the first branch portion and the first trunk portion; the common electrode includes a second trunk portion and second branch portions, a second preset angle is defined between the second branch portion and the second trunk portion; wherein the first branch portions and the second branch portions are parallel to each other and alternatively arranged.

Another object of the present invention is to provide a manufacturing method of a liquid crystal display panel, which comprises the following steps:

providing a first substrate, and forming common electrodes and pixel electrodes on the first substrate;

providing a second substrate, attaching the second substrate to the first substrate, and injecting a mixture of reactive monomers and positive liquid crystal molecules into a space between the second substrate and the first substrate; and

forming an electric field in a liquid crystal layer, and lighting the liquid crystal layer, so that the reactive monomers react and the positive liquid crystal molecules form a pre-tilt angle.

In one embodiment of the present invention, the step of forming the common electrodes and pixel electrodes on the first substrate includes:

forming a first transparent electrode layer on the first substrate, and performing an exposure process and an etching process to the first transparent electrode layer to form the common electrodes and the pixel electrodes.

In one embodiment of the present invention, the step of forming the common electrodes and pixel electrodes on the first substrate includes:

forming a second transparent electrode layer on the first substrate, and performing an exposure process and an etching process to the second transparent electrode layer to form the common electrodes;

forming an insulation layer on the common electrodes;

coating a third transparent conductive layer on the insulation layer, and performing an exposure process and an etching process to the third transparent conductive layer to form the pixel electrodes.

In one embodiment of the present invention, the pixel electrodes and the common electrodes are alternately arranged, and a plurality of the alignment display regions are formed by the pixel electrodes and the common electrodes arranged alternately.

In one embodiment of the present invention, the pixel electrodes and the common electrodes have bent structures and are alternately arranged.

In one embodiment of the present invention, the pixel electrode includes a first trunk portion and first branch portions, a first preset angle is defined between the first branch portion and the first trunk portion; the common electrode includes a second trunk portion and second branch portions, a second preset angle is defined between the second branch portion and the second trunk portion; wherein the first branch portions and the second branch portions are parallel to each other and alternatively arranged.

With respect to the prior art, the present invention provides the steps of disposing the pixel electrodes and the common electrodes on the same substrate, and injecting a mixture of reactive monomers and positive liquid crystal molecules into the liquid crystal layer, and then applying voltages and the ultraviolet light to the two transparent substrates, such that the reactive monomer and the liquid crystal molecules in the liquid crystal layer occur the phase separation, and at the same time of forming a layer of polymer on the alignment base material of the transparent substrate, the positive liquid crystal molecules are also formed with a pre-tilt angle. Because the positive liquid crystal molecules have fast response speed, they can improve the efficiency of the alignment without the step of operating the rubbing alignment, which can save cost and be suitable for large-scale production.

In order to clarify and simplify the above description of the present invention, the following contents held specially the preferred embodiment with the accompanying drawings as described in detail as following:

### DESCRIPTION OF THE DRAWINGS

FIG. 1 is a partially cross-sectional view of the liquid crystal display panel according to a first preferred embodiment of the present invention;

FIG. 2 is a top structural view of the liquid crystal display panel according to one embodiment of FIG. 1;

FIG. 3 is a top structural view of the liquid crystal display panel according to another embodiment of FIG. 1;

FIG. 4 is a partially cross-sectional view of the liquid crystal display panel according to a second preferred embodiment of the present invention;

FIG. 5 is a flowchart of the manufacturing method of the liquid crystal display panel according to the first preferred embodiment of the present invention; and

FIG. 6 is a flowchart of the manufacturing method of the liquid crystal display panel according to the second preferred embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, and etc., are only directions by referring to the accompanying drawings, and thus the used directional terms are used to describe and understand the present invention, but the present invention is not limited thereto.

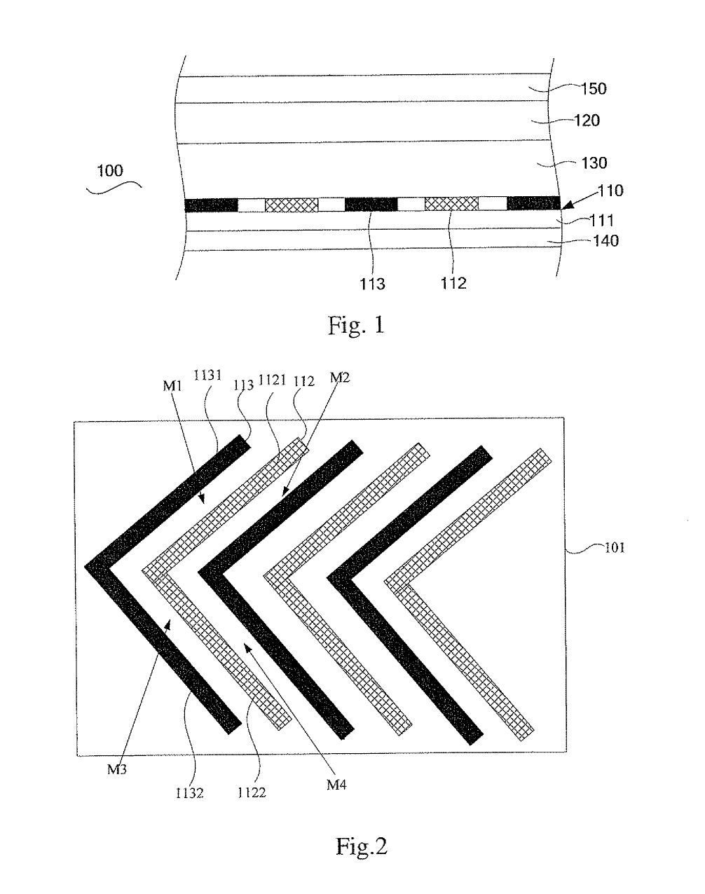

Please referring to FIG. 1, it is a partially cross-sectional view of a liquid crystal display panel according to a first preferred embodiment of the present invention is illustrated. The liquid crystal display panel 100 of the present embodiment and a backlight module (not shown in Figs.) are composited as a display device. The backlight module device is disposed on a side of the liquid crystal display panel 100, such as a side lighting type backlight module or a bottom lighting type backlight module, can provide the backlight to the liquid crystal display panel 100.

As shown in FIG. 1, the liquid crystal display panel 100 comprises a first substrate 110, a second substrate 120, a liquid crystal layer 130, a first polarizer 140 and a second polarizer 150, wherein the liquid crystal layer 130 is formed between the first substrate 110 and the second substrate 120, and the liquid crystal layer 130 is formed on the inner side of the first substrate 110 and the second substrate 120. And, the liquid crystal layer 130 is formed by the positive liquid crystal molecules. The first polarizer 140 is disposed on the outer side of the first substrate 110, and the second polarizer 150 is disposed on the outer side of the second substrate 120. The first substrate 110 is a thin film transistor (TFT) array substrate and the second substrate 120 is a color filter (CF) substrate. It is worth noting that, in some embodiments, the TFT array and the color filter may also be disposed on the same substrate.

The first substrate 110 further includes a first base 111, and pixel electrodes 112 and common electrodes 113 are formed on the first base 111. In the embodiment, the pixel electrodes 112 and the common electrodes 113 are formed by a same transparent electrode layer.

Please referring to FIG. 2, it is a top structural view of the liquid crystal display panel of the embodiment in FIG. 1. A plurality of signal lines and thin film transistors (not shown in Figs.) are formed on the first base 111, and the signal lines are gate lines and data lines. The gate lines and the data lines are perpendicular to each other and interleaved to form a plurality of pixel region 101, such as red, green and blue sub-pixel regions, and the red, green and blue sub-pixel regions are formed to be a pixel.

The pixel electrode 112 is provided with a first pixel electrode branch 1121 and a second pixel electrode branch 1122, the first pixel electrode branch 1121 and the second pixel electrode branch 1122 are connected with each other, and the pixel electrode 112 is bent shape. The common electrode 113 is provided with a first common electrode branch 1131 and a second common electrode branch 1132, the first common electrode branch 1131 and the second common electrode branch 1132 are connected with each other, and the common electrode 113 is bent shape. The pixel electrodes 112 and the common electrodes 113 are alternately arranged, and the first pixel electrode branch 1121 and the first common electrode branch 1131 are disposed in parallel to each other. The second pixel electrode branch 1122 and the second common electrode branch 1132 are disposed in parallel to each other. More preferably, the first pixel electrode branch 1121 and the second pixel electrode branch 1122 are vertically connected with each other, and the first common electrode branch 1131 and the second common electrode branch 1132 are vertically connected to each other. Of cause, an angle between the first pixel electrode branch 1121 and the second pixel electrode branch 1122, and an angle between the first common electrode branch 1131 and the second common electrode branch 1132 may also be other angles, such as 60 degrees.

In the present embodiment, the pixel electrodes 112 and the common electrodes 113 are substantially “V” type, of course, the pixel electrodes 112 and the common electrodes 113 may also be bent structure of other forms, such as “W” shape, or combined with linear type in the “W” type and the like.

In the embodiment in FIG. 2, four alignment display regions are formed between the pixel electrodes 112 and the common electrodes 113, and they are the regions which are marked by arrows M1, M2, M3 and M4. And, pre-tilt angles of positive liquid crystal molecules are different in the alignment display regions M1, M2, M3 and M4. The positive liquid crystal molecules in the alignment display regions M1 have a first pre-tilt angle; the positive liquid crystal molecules in the alignment display regions M2 have a second pre-tilt angle; the positive liquid crystal molecules in the alignment display regions M3 have a third pre-tilt angle; and the positive liquid crystal molecules in the alignment display regions M4 have a fourth pre-tilt angle. And, the above-mentioned first, second, third and fourth pre-tilt angles are different from each other, so that the angles of the emitted lights are also different individually, which may effectively avoid the problem of the chromatic aberration.

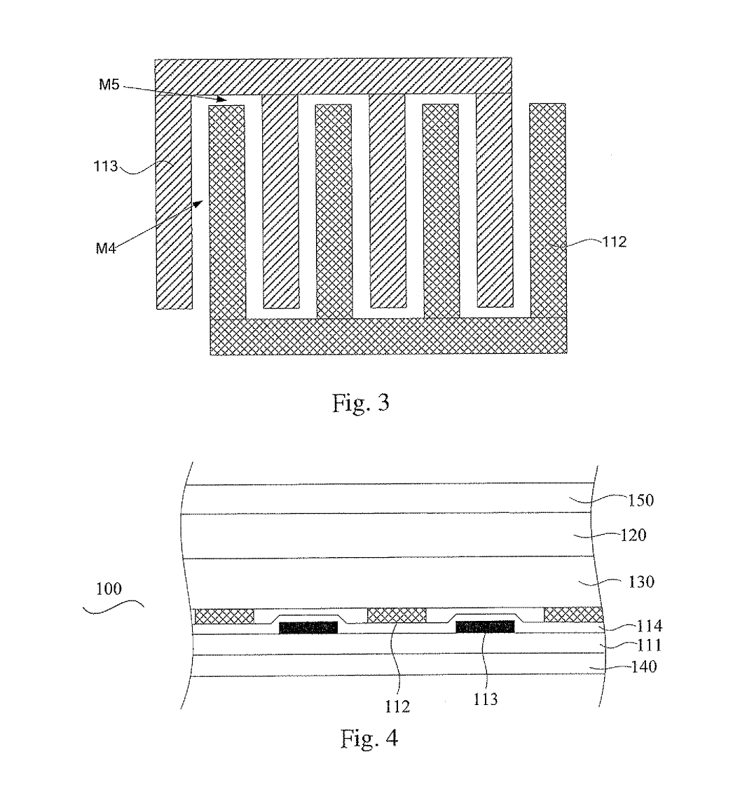

Please referring with FIG. 3, it is a top structural view of the liquid crystal display panel of another embodiment in FIG. 1. In the embodiment, the pixel electrode 112 is provided with a first trunk portion 1121 and a plurality of first branch portions 1122, wherein the first branch portions 1122 and the first trunk portion 1121 connected with each other, and a first preset angle, such as 90 degrees, is between the first branch portions 1122 and the first trunk portion 1121. The common electrode 113 includes a second trunk portion 1131 and a plurality of second branch portions 1132, and the second trunk portion 1131 and a plurality of the second branch portions 1132 are connected with each other, and a second preset angle, such as 90 degrees, is between the second trunk portion 1131 and a plurality of the second branch portions 1132. The first trunk portion 1121 and the second trunk portion 1131 are disposed in parallel to each other. And the first branch portions 1122 and the second branch portions 1132 are alternately arranged and disposed in parallel to each other. And, the first branch portions 1122 and the second branch portions 1132 are disposed between the first trunk portion 1121 and the second trunk portion 1131.

As shown in FIG. 3, the pixel electrodes 112 and the common electrodes 113 may be formed in two alignment display regions M4 and M5, and the preset angles of the positive liquid crystal molecules in the alignment display region M4 and M5 are different.

Please referring to FIG. 4, it is a partially cross-sectional view of the liquid crystal display panel according to a second preferred embodiment of the present invention. In the embodiment shown in FIG. 3, the pixel electrodes 112 and the common electrodes 113 are formed on different layer. More specifically, the common electrodes 113 are formed on the first base 111 and forming an insulation layer 114 on the common electrodes 113 and the first base 111. The pixel electrodes 112 are formed on the insulation layer 114. In the present embodiment, the planar structure and the arrangement of the pixel electrodes 112 and the common electrodes 113 are the same as that of the first preferred embodiment in FIG. 1.

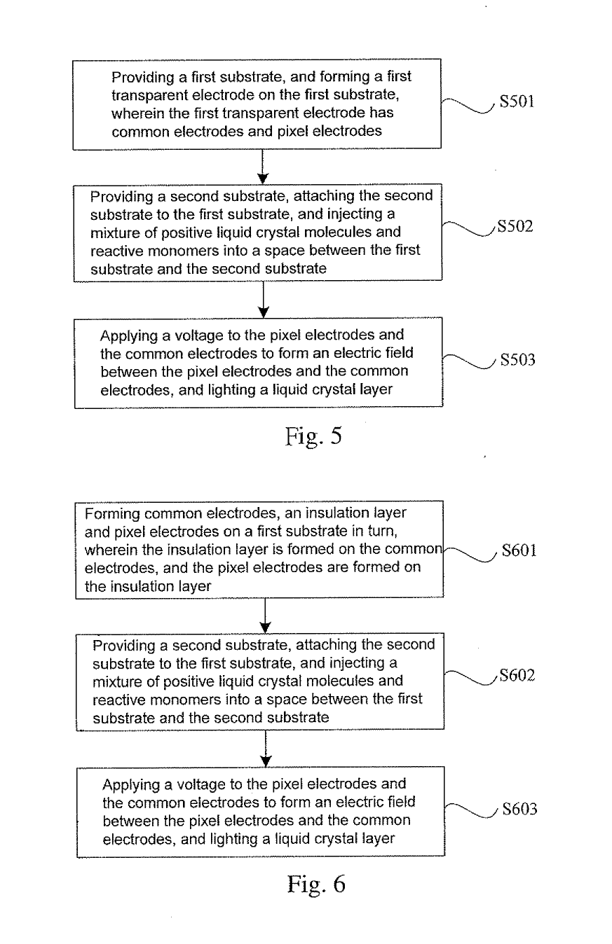

Please referring to FIG. 5, it is a flowchart of the manufacturing method of the liquid crystal display panel according to the first preferred embodiment of the present invention, and the manufacturing method includes:

In the step S501: providing a first substrate, and forming a first transparent electrode layer on the first substrate, and performing an exposure process and an etching process to the first transparent electrode layer to form the common electrodes and the pixel electrodes.

The pixel electrodes and the common electrodes are alternately arranged to form a plurality of alignment display regions. For example, please also referring to FIG. 2, in FIG. 2, the pixel electrodes and the common electrodes are bend structures. Or please referring to FIG. 3, in FIG. 3, the pixel electrodes and the common electrodes both include the trunk portions and the branch portions, wherein preset angles are between the trunk portions and the branch portions, and each of the branch portions are alternately disposed and are parallel to each other.

In the step S502, providing a second substrate, and attaching the second substrate to the first substrate, and then injecting a mixture of reactive monomers and positive liquid crystal molecules into a space between the second substrate and the first substrate.

In the step S503, applying a voltage to the pixel electrode and the common electrode to form an electric field between the pixel electrode and the common electrode, and lighting a liquid crystal layer, such as the ultraviolet light.

Under the effect of the electric field, the positive liquid crystal molecules rotate; and under the effect of the illumination, reactive monomers are activated to form polymers, the direction of which is along the direction of the inclination angle of the positive liquid crystal molecules, and then removing the voltage, so that the positive liquid crystal molecules form a pre-tilt angle of a certain angle. The residual reactive monomers can be lighten or treated by heat treatment such that its reaction can be completed.

Please referring to FIG. 6, it is a flowchart of the manufacturing method of the liquid crystal display panel according to the second preferred embodiment of the present invention.

In step S601, providing the first substrate, forming common electrodes, an insulation layer and pixel electrodes on a first substrate in turn, wherein the insulation layer is formed on the common electrodes, and the pixel electrodes are formed on the insulation layer.

In the specific implementation process, firstly forming a second transparent electrode layer on the first substrate, and performing an exposure process and an etching process to the second transparent electrode layer to form the common electrodes, and then forming the insulation layer on the common electrodes, and forming a third transparent conductive layer, and performing an exposure process and an etching process to the third transparent conductive layer to form the pixel electrodes.

The pixel electrodes and the common electrodes are alternately arranged to form a plurality of alignment display regions. For example, please also referring to FIG. 2, in FIG. 2, the pixel electrodes and the common electrodes are bend structures. Or please referring to FIG. 3, in FIG. 3, the pixel electrodes and the common electrodes both include the trunk portions and the branch portions, wherein preset angles are between the trunk portions and the branch portions, and each of the branch portions are alternately disposed and are parallel to each other.

In the step S602, providing a second substrate, and attaching the second substrate to the first substrate, and then injecting a mixture of reactive monomers and positive liquid crystal molecules into a space between the second substrate and the first substrate.

In the step S603, applying a voltage to the pixel electrode and the common electrode to form an electric field between the pixel electrode and the common electrode, and lighting a liquid crystal layer, such as the ultraviolet light.

Under the effect of the electric field, the positive liquid crystal molecules rotate; and under the effect of the illumination, reactive monomers are activated to form polymers, the direction of which is along the direction of the inclination angle of the positive liquid crystal molecules, and then removing the voltage, so that the positive liquid crystal molecules form a pre-tilt angle of a certain angle. The residual reactive monomers can be lighten or treated by heat treatment such that its reaction can be completed.

In the present invention, because the liquid crystal layer is filled by the positive liquid crystal molecules, the rotational viscosity of the positive liquid crystal molecules is lower and its response is faster, and in the alignment process, they can improve the rate of the alignment; and the present invention does not need the rubbing step to form the alignment layer, so that it considerably reduces the cost and is suitable for large-scale production.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A liquid crystal display panel, comprising:
a first substrate provided with common electrodes and pixel electrodes thereon, wherein the pixel electrodes and the common electrodes are alternately arranged, and a plurality of the alignment display regions are formed by the pixel electrodes and the common electrodes arranged alternately;
a second substrate disposed opposite to the first substrate; and
a liquid crystal layer formed between the first substrate and the second substrate, and including positive liquid crystal molecules which have a pre-tilt angle, wherein the pre-tilt angle of the positive liquid crystal molecules corresponding to each of the alignment display regions is different.

2. The liquid crystal display panel according to claim 1, wherein the pixel electrodes and the common electrodes are formed on the same layer.

3. The liquid crystal display panel according to claim 1, wherein an insulation layer is formed on the common electrodes and the pixel electrodes are formed on the insulation layer.

4. The liquid crystal display panel according to claim 1, wherein the pixel electrodes and the common electrodes have bent structures and are alternately arranged.

5. The liquid crystal display panel according to claim 1, wherein the pixel electrode includes a first trunk portion and first branch portions, a first preset angle is defined between the first trunk portion and the first branch portion; the common electrode includes a second trunk portion and second branch portions, a second preset angle is defined between the second branch portion and the second trunk portion; wherein the first branch portions and the second branch portions are parallel to each other and alternatively arranged.

6. A liquid crystal display panel, comprising:
a first substrate provided with common electrodes and pixel electrodes thereon;
a second substrate disposed opposite to the first substrate; and
a liquid crystal layer formed between the first substrate and the second substrate, and including positive liquid crystal molecules which have a pre-tilt angle.

7. The liquid crystal display panel according to claim 6, wherein the pixel electrodes and the common electrodes are formed on the same layer.

8. The liquid crystal display panel according to claim 6, wherein an insulation layer is formed on the common electrodes and the pixel electrodes are formed on the insulation layer.

9. The liquid crystal display panel according to claim 6, wherein the pixel electrodes and the common electrodes are alternately arranged, and a plurality of the alignment display regions are formed by the pixel electrodes and the common electrodes arranged alternately.

10. The liquid crystal display panel according to claim 9, wherein the pixel electrodes and the common electrodes have bent structures and are alternately arranged.

11. The liquid crystal display panel according to claim 9, wherein the pixel electrode includes a first trunk portion and first branch portions, a first preset angle is defined between the first branch portion and the first trunk portion; the common electrode includes a second trunk portion and second branch portions, a second preset angle is defined between the second branch portion and the second trunk portion; wherein the first branch portions and the second branch portions are parallel to each other and alternatively arranged.

12. A manufacturing method of a liquid crystal display panel, comprising steps of:
providing a first substrate, and forming common electrodes and pixel electrodes on the first substrate;
providing a second substrate, attaching the second substrate to the first substrate, and injecting a mixture of reactive monomers and positive liquid crystal molecules into a space between the second substrate and the first substrate; and
forming an electric field in a liquid crystal layer, and lighting the liquid crystal layer, so that the reactive monomers react and the positive liquid crystal molecules form a pre-tilt angle.

13. The manufacturing method of the liquid crystal display panel according to claim 12, wherein the step of forming the common electrodes and pixel electrodes on the first substrate includes:
forming a first transparent electrode layer on the first substrate, and performing an exposure process and an etching process to the first transparent electrode layer to form the common electrodes and the pixel electrodes.

14. The manufacturing method of the liquid crystal display panel according to claim 12, wherein the step of forming the common electrodes and pixel electrodes on the first substrate includes:
forming a third transparent electrode layer on the first substrate, and performing an exposure process and an etching process to the third transparent electrode layer to form the common electrodes;
forming an insulation layer on the common electrodes;
coating a third transparent conductive layer on the insulation layer, and performing an exposure process and an etching process to the third transparent conductive layer to form the pixel electrodes.

15. The manufacturing method of the liquid crystal display panel according to claim 12, wherein the pixel electrodes and the common electrodes are alternately arranged, and a plurality of the alignment display regions are formed by the pixel electrodes and the common electrodes arranged alternately.

16. The manufacturing method of the liquid crystal display panel according to claim 5, wherein the pixel electrodes and the common electrodes have bent structures and are alternately arranged.

17. The manufacturing method of the liquid crystal display panel according to claim 5, wherein the pixel electrode includes a first trunk portion and first branch portions, a first preset angle is defined between the first branch portion and the first trunk portion; the common electrode includes a second trunk portion and second branch portions, a second preset angle is defined between the second branch portion and the second trunk portion; wherein the first branch portions and the second branch portions are parallel to each other and alternatively arranged.
